(19) United States
(12) Patent Application Publication
(10) Pub. No.: US 2021/0176439 A1
(43) Pub. Date: Jun. 10, 2021

(54) PROJECTOR, PROJECTOR CONTROL METHOD, AND PROJECTOR CONTROL PROGRAM

(71) Applicant: KANTATSU CO., LTD., Yaita-shi, Tochigi (JP)

(72) Inventors: Eiji OSHIMA, Yaita-shi, Tochigi (JP); Norio MATSUDA, Yaita-shi, Tochigi (JP)

(21) Appl. No.: 16/640,644

(22) PCT Filed: Nov. 14, 2017
(86) PCT No.: PCT/JP2017/040864

§ 371 Date: Dec. 7, 2020

(30) Foreign Application Priority Data
Aug. 25, 2017 (JP) 2017-161700

(51) Int. Cl. H04N 9/31

(52) U.S. Cl. CPC H04N 9/3152; H04N 9/3129

(57) ABSTRACT

A projector (100) of the present invention includes: a light source (101) configured to generate light; an optical system (102) configured to reflect the light from the light source (101) and guide the light to a two-dimensional scanning mirror (103); the two-dimensional scanning mirror (103) configured to project the light guided by the optical system (102) on a screen; and a driving mechanism (104) configured to drive the optical system (102) at a predetermined period and a predetermined amplitude, and reduces speckle noise with a simple configuration.

### TECHNICAL FIELD

The present invention relates to a projector, a method of controlling a projector, and a program for controlling a projector.

### BACKGROUND ART

In the above technical field, PTL 1 discloses a technique to reduce speckle noise by directly moving a screen, which is one of speckle noise sources.

### CITATION LIST

### Non-Patent Literature

NPL 1: Muneharu KUWARA and six others, “Reducing Speckle in Laser Displays with Moving Screen System”, The Journal of The Institute of Image Information and Television Engineers Vol. 65 No. 2, pp. 224-228 (2011) 65_224

### SUMMARY OF INVENTION

### Technical Problem

However, the technique described in NPL 1 causes a screen as a physically large device to be subjected to direct moving and thus causes the apparatus for speckle noise reduction to increase in size, failing to reduce speckle noise with a simple configuration.

### Solution to Problem

It is an object of the present invention to provide a technique to solve the above problems.

To achieve the above object, a projector according to the present invention includes:

a light source configured to generate light;

an optical system configured to reflect the light from the light source and guide the light to a two-dimensional scanning mirror;

the two-dimensional scanning mirror configured to project the light guided by the optical system on a screen; and

a driving mechanism configured to drive the optical system at a predetermined period and a predetermined amplitude.

To achieve the above object, a method of controlling a projector according to the present invention, the projector including

a light source configured to generate light,

an optical system configured to reflect the light from the light source and guide the light to a two-dimensional scanning mirror,

the two-dimensional scanning mirror configured to project the light guided by the optical system on a screen, and

a driving mechanism configured to drive the optical system at a predetermined period and a predetermined amplitude, the method comprising the steps of:

generating light from the light source;

projecting the generated light on the screen; and

driving the optical system.

To achieve the above object, a program for controlling a projector according to the present invention, the projector including

a light source configured to generate light,

an optical system configured to reflect the light from the light source and guide the light to a two-dimensional scanning mirror,

the two-dimensional scanning mirror configured to project the light guided by the optical system on a screen, and

a driving mechanism configured to drive the optical system at a predetermined period and a predetermined amplitude, the program causing a computer to execute a method of controlling the projector, the method including the steps of:

generating light from the light source;

projecting the generated light on the screen; and

driving the optical system.

### Advantageous Effects of Invention

The present invention allows reduction in speckle noise with a simple configuration.

### BRIEF DESCRIPTION OF THE DRAWINGS

FIG. 1 is a diagram illustrating configuration of a projector according to a first embodiment of the present invention.

FIG. 2A is a diagram illustrating speckle noise generation by a projector in a prerequisite technique for a projector according to a second embodiment of the present invention.

FIG. 2B is a diagram illustrating an overview of reduction in speckle noise by the projector according to the second embodiment of the present invention.

FIG. 3A is a diagram illustrating configuration of the projector according to the second embodiment of the present invention.

FIG. 3B is a partial enlarged view illustrating configuration of a drive section of the projector according to the second embodiment of the present invention.

FIG. 3C is a partial enlarged view illustrating configuration of another drive section of the projector according to the second embodiment of the present invention.

FIG. 4 is a diagram illustrating a driving pattern by the drive section of the projector according to the second embodiment of the present invention.

FIG. 5 is a flow chart illustrating a processing procedure by the projector according to the second embodiment of the present invention.

FIG. 6 is a diagram illustrating configuration of a projector according to a third embodiment of the present invention.

### DESCRIPTION OF EMBODIMENTS

Embodiments of the present disclosure are exemplarily described below with reference to the drawings. It should be noted that the configuration, the numerical values, the process flows, the functional components, and the like described in the embodiments below are merely examples and may be freely modified or altered. The technical scope of the present invention is not intended to be limited to the following description.

### First Embodiment

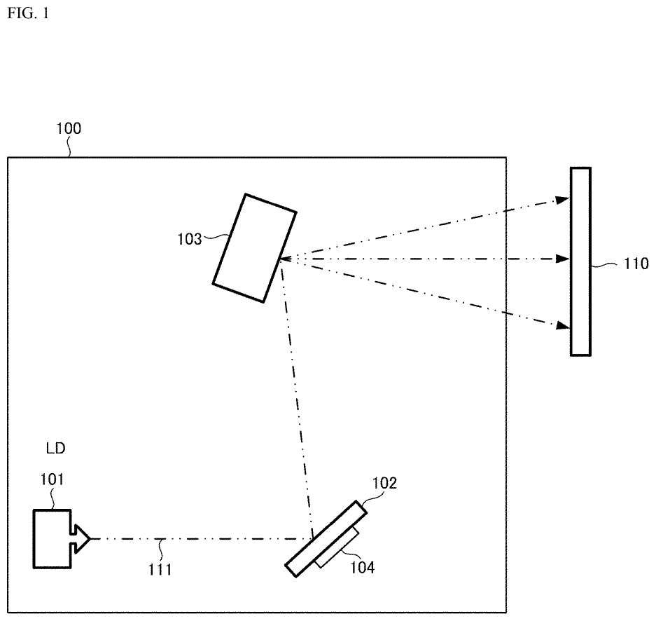

As the first embodiment of the present invention, a projector 100 is described with reference to FIG. 1. The projector 100 is a device configured to project an image on a screen.

As illustrated in FIG. 1, the projector 100 includes a light source 101, an optical system 102, a two-dimensional scanning mirror 103, and a drive section 104.

The light source 101 generates light. The optical system 102 reflects the light from the light source 101 and guides the light to the two-dimensional scanning mirror 103. The two-dimensional scanning mirror 103 projects the light guided by the optical system 102 on a screen 110. The drive section 104 drives the optical system 102 at a predetermined period and a predetermined amplitude.

The present embodiment allows reduction in speckle noise with a simple configuration.

### Second Embodiment

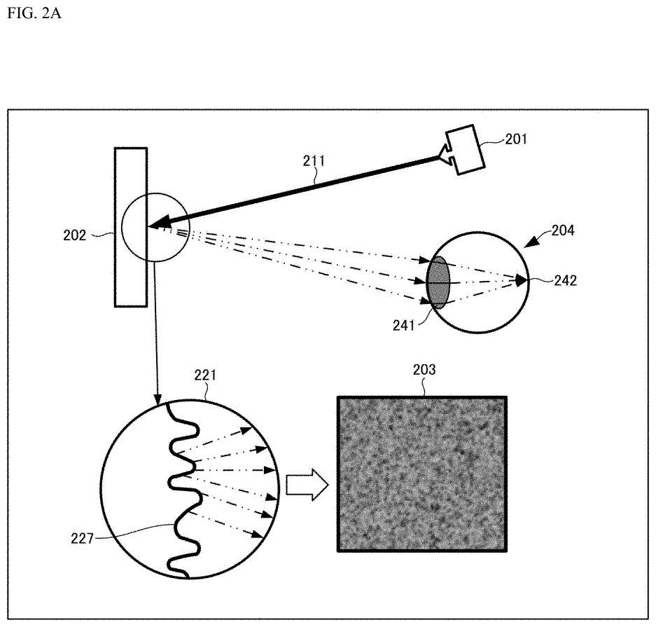

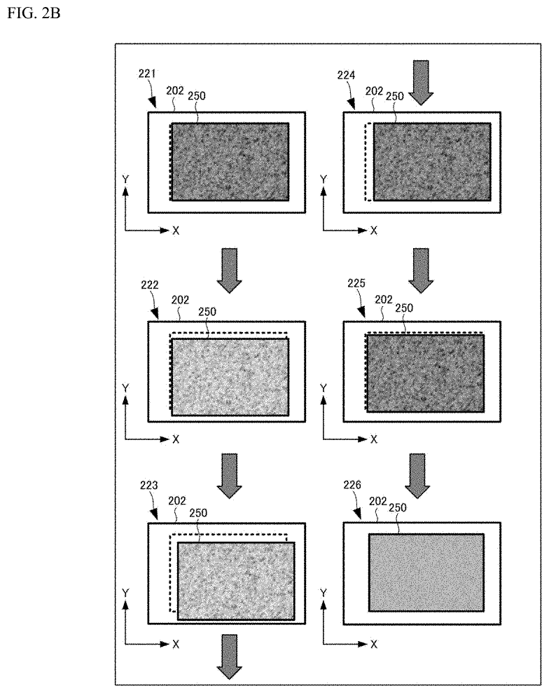

With reference to FIGS. 2A through 4, a projector according to the second embodiment of the present invention is then described. FIG. 2A is a diagram illustrating speckle noise generation by a projector in a prerequisite technique for the projector according to the present embodiment. When laser light 211 from a laser light source 201 is projected on a screen 202, as illustrated in an enlarged view (221) of the area where the laser light 211 is projected, a surface 227 of the screen 202 is uneven and the laser light 211 is thus scattered on the surface 227 of the screen 202. When a person looks at an image or the like projected on the screen 202, the scattered laser light 211 is coherent with each other. Accordingly, when the coherent light passes through the crystalline lens 241 of the human eyeball 204 and forms an image on the retina 242, the image appears to flicker. This is speckle noise 203 as a tiny speckle pattern.

FIG. 2B is a diagram illustrating an overview of reduction in speckle noise by the projector according to the present embodiment.

In the projector according to the prerequisite technique illustrated in FIG. 2A, an image or the like is constantly drawn in the same position and thus the scattered light becomes coherent. To prevent this, the position where the laser light 211 from the laser light source 201 is projected on the screen 202 is slightly shifted (moved). This allows variation in interference patterns of the scattered light. Generation of the plurality of interference patterns then causes averaging of the interference patterns, and as a result, allows reduction in the speckle noise 203. In this context, a movement (amount of shifting) of the projected position is a displacement as small as approximately one pixel.

With reference to FIG. 2B, a first frame 221 represents a reference position 250 (X=0, Y=0) for drawing. In a second frame 222, the reference position 250 for drawing is shifted by one pixel in a −Y direction for drawing (X=0, Y=−1). In a third frame 223, the reference position 250 for drawing is shifted by one pixel in a +X direction for drawing (X=1, Y=−1). In a fourth frame 224, the reference position 250 for drawing is shifted by one pixel in a +Y direction for drawing (X=1, Y=0). In a fifth frame 225, the reference position 250 for drawing is shifted by one pixel in a −X direction for drawing (X=0, Y=0). In a sixth frame 226, the four frames from the second frame 222 to the fifth frame 225 are averaged to allow reduction (decrease) in speckle noise. Note that one frame is assumed to represent 1/60 of a second.

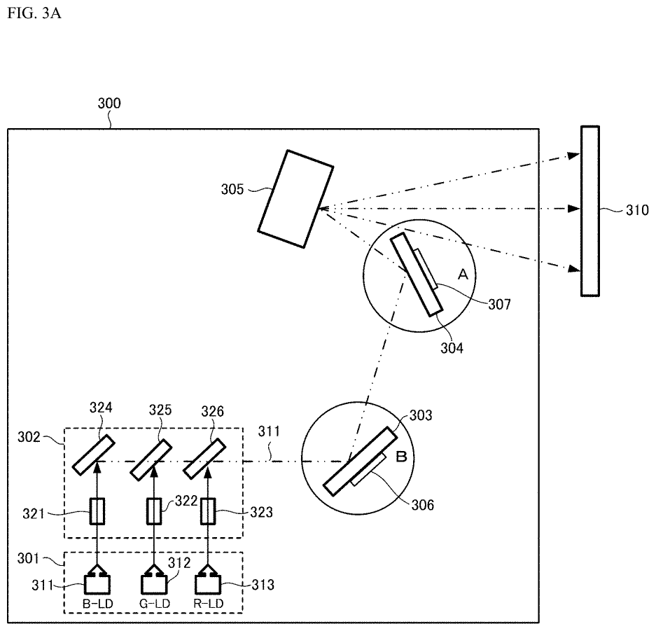

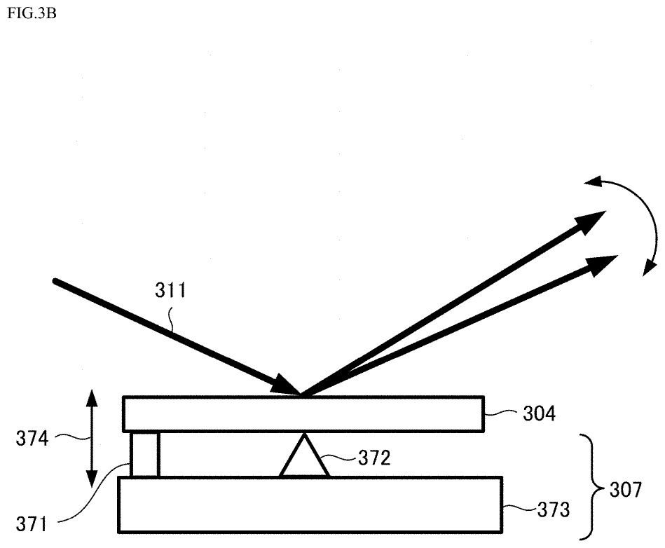

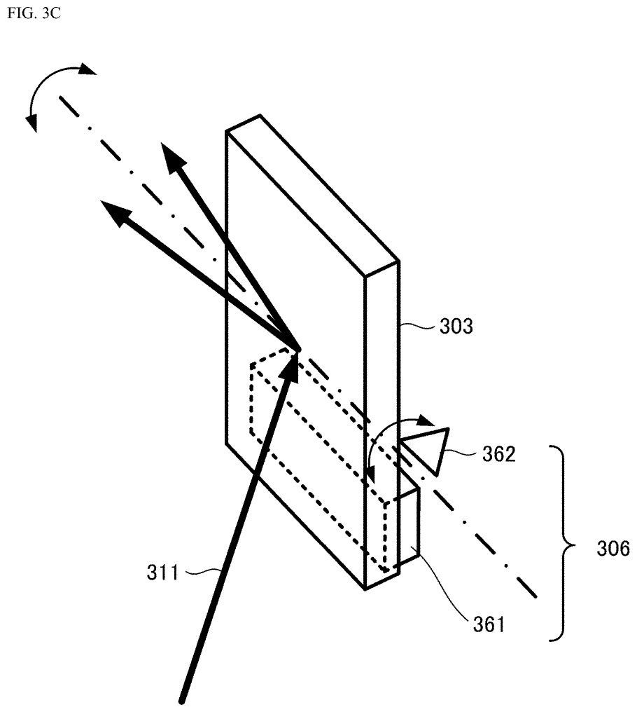

FIG. 3A is a diagram illustrating configuration of a projector 300 according to the present embodiment. The projector 300 has a light source 301, a light beam adjustment section 302, a mirror 303, a mirror 304, a two-dimensional scanning mirror 305, a drive section 306, and a drive section 307. The projector 300 is configured to project an image on a screen 310.

The light source 301 is, for example, an RGB LD (RGB laser diode). The light source 301 further has a B-LD 311 (blue), a G-LD 312 (green), and R-LD 313 (red). Light beams generated by the light source 301 are then incident on the light beam adjustment section 302. The light beam adjustment section 302 includes collimators 321, 322, and 323 and mirrors 324, 325, and 326. The mirrors 324, 325, and 326 are, for example, dichroic mirrors. The light beam adjustment section 302 is an optical device that converts the laser light generated from the light source 301 to parallel light and synthesize RGB laser light.

The light beams incident on the light beam adjustment section 302 become parallel light in the collimators 321, 322, and 323 and then incident on the mirrors 324, 325, and 326. The light beams reflected on the mirrors 324, 325, and 326 are synthesized and exit the light beam adjustment section 302 to be incident on the mirror 303 as a light beam 311. The light beam 311 incident on the mirror 303 is reflected on the mirror 303 and then incident on the mirror 304. The light incident on the mirror 304 is reflected on the mirror 304 and then incident on the two-dimensional scanning mirror 305. The light incident on the two-dimensional scanning mirror 305 is projected on the screen 310 from the two-dimensional scanning mirror 305.

The mirror 303 is a mirror to reflect the light beam 311 from the light source 301. The mirror 303 reflects the light beam 311 to the mirror 304. The mirror 303 is, but not limited to, a dichroic mirror, for example.

The mirror 304 is a mirror to reflect the light beam 311 reflected on the mirror 303. The mirror 304 reflects the light beam 311 to the two-dimensional scanning mirror 305. The mirror 304 is, but not limited to, a fold mirror, for example. At least one of the mirrors 303 and 304 may be a dichroic mirror or a fold mirror, or both may be dichroic mirrors or fold mirrors.

The two-dimensional scanning mirror 305 is a mirror to project the light beam 311 reflected on the mirror 304 on the screen 310. The two-dimensional scanning mirror 305 is, for example, a two-dimensional MEMS (micro electro mechanical system) mirror. The two-dimensional scanning mirror 305 is a driving mirror driven based on a control signal input from outside and is a device that vibrates to reflect laser light by varying the angle in the horizontal direction (X direction) and the vertical direction (Y direction). Instead of using the two-dimensional scanning mirror 305, the two-dimensional scanning mirror may be configured using, for example, two one-dimensional scanning mirrors.

The mirror 303 is provided with the drive section 306, and the mirror 304 is provided with the drive section 307. The drive sections 306 and 307 drive the mirrors 303 and 304 to vibrate them. When the mirrors 303 and 304 are driven (vibrated) by the drive sections 306 and 307, the position where the light beam 311 generated from the light source 301 is projected varies and no image is depicted in the same position on the screen 310. The amounts of driving by the drive sections 306 and 307 are, for example, amounts to the extent of not being visible to human eyes and similarly the periods of driving by the drive sections 306 and 307 are also periods to the extent of not being detected by human eyes while the amounts and the periods are not limited to above.

The drive section 306 drives (vibrates) the mirror 303 to shift the reference position 250 for drawing (drawing area) of one frame only by one pixel. The driving direction is, for example, the X direction while it may be the Y direction. The drive section 307 similarly drives the mirror 304 to shift the reference position 250 for drawing (drawing area) of one frame only by one pixel. The driving direction is, for example, the Y direction while it may be the X direction. The driving directions by the drive sections 306 and 307 may be in the same direction, directions different from each other, or directions orthogonal to each other while they are not limited to these directions. The drive sections 306 and 307 may be provided in either one of the mirrors 303 and 304. The number of the mirrors 303 and 304 is not limited to two and may be three or more. If the number of mirrors is three or more, such a drive section may be provided in part or all mirrors.

FIG. 3B is a partial enlarged view illustrating configuration of the drive section 307 of the projector 300 according to the present embodiment. The drive section 307 has a piezoelectric element 371, a fulcrum member 372, and a base member 373. The piezoelectric element 371 and the fulcrum member 372 are mounted on the base member 373. The drive section 307 drives (vibrates) the mirror 304, for example, in the X direction.

When a voltage is applied to the piezoelectric element 371, the piezoelectric element 371 expands or contracts in the direction of an arrow 374 to move the mirror 304 about the fulcrum member 372 as a pivot. Since the mirror 304 thus moves, the light beam 311 reflected on the mirror 304 also moves. The amount of driving (moving, vibrating) the mirror 304 is an amount to shift the reference position 250 for drawing of one frame only by one pixel. The drive section 307 drives the mirror 304, for example, in the X direction.

FIG. 3C is a partial enlarged view illustrating configuration of the other drive section 306 of the projector 300 according to the present embodiment. The drive section 306 has a piezoelectric element 361 and a fulcrum member 362. The drive section 306 also has a base member, not shown. The piezoelectric element 361 and the fulcrum member 362 are mounted on the base member. The drive section 306 drives the mirror 303, for example, in the Y direction.

When a voltage is applied to the piezoelectric element 361, the piezoelectric element 361 expands or contracts to move the mirror 303 about the fulcrum member 362 as a pivot. Since the mirror 303 thus moves, the light beam 311 reflected on the mirror 303 also moves. The amount of driving (moving, vibrating) the mirror 303 is an amount to shift the reference position 250 for drawing of one frame only by one pixel. The drive section 306 drives the mirror 303, for example, in the Y direction.

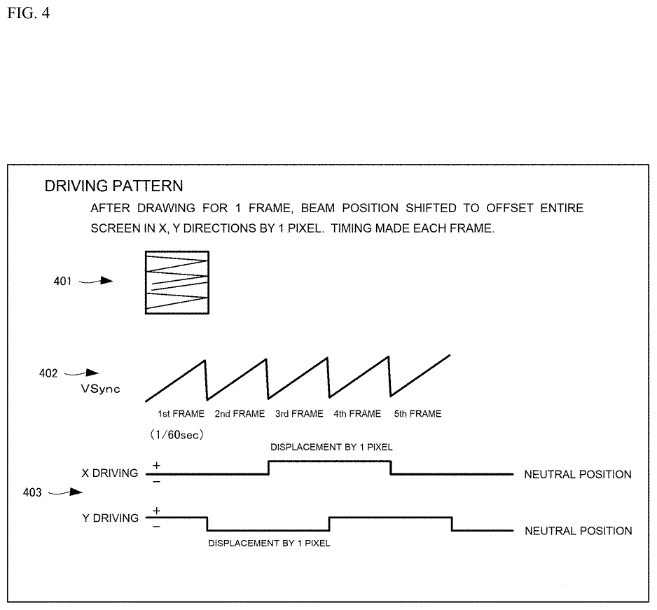

FIG. 4 is a diagram illustrating a driving pattern by the drive sections 306 and 307 of the projector 300 according to the present embodiment. As indicated by 401, after drawing for one frame, the position of the light beam 311 is shifted to offset the entire screen in the X direction and the Y direction by one pixel. The amount (magnitude) of driving is not limited to the magnitude of one pixel and may be a predetermined amplitude (magnitude).

In addition, 402 indicates timing, that is, the timing (predetermined period) to drive the mirrors 303 and 304 by the drive sections 306 and 307, and the drive sections 306 and 307 drive (shift) them, for example, for each frame. It should be noted that the timing for driving is not limited to this. The reference numeral 403 indicates driving in the X direction and driving in the Y direction. A neutral position indicates a state where the mirrors 303 and 304 are not driven.

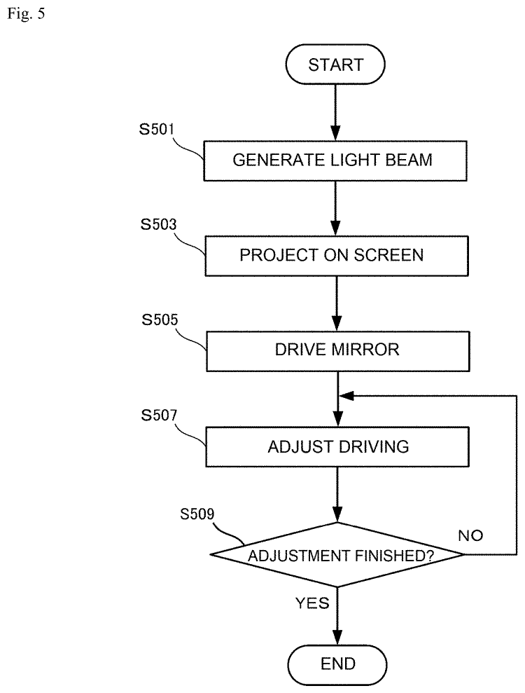

FIG. 5 is a flow chart illustrating a processing procedure by the projector 300 according to the present embodiment. At step S501, the projector 300 causes the light beam 311 to be generated from the light source 301. At step S503, the projector 300 causes the generated light beam 311 to be projected on the screen 310. At step S505, the projector 300 causes the mirrors 303 and 304 to be driven. At step S507, the projector 300 adjusts the driving of the mirrors 303 and 304. The adjustment is made by varying the period and/or the amplitude based on, for example, a feedback image of the image projected on the screen 310 or the like while the adjustment is not limited to this method. At step S509, the projector 300 determines whether the adjustment of driving is finished. When determined that the adjustment is not finished (NO at step S509), the projector 300 returns to step S507 and continues the adjustment. When determined that the adjustment is finished (YES at step S509), the projector 300 is finished with the process.

Since the optical devices on an optical path are driven, the present embodiment allows reduction in speckle noise without increasing optical devices. In addition, since the mechanism to drive the optical devices on an optical path is provided, the present embodiment allows reduction in speckle noise with a simple configuration.

### Third Embodiment

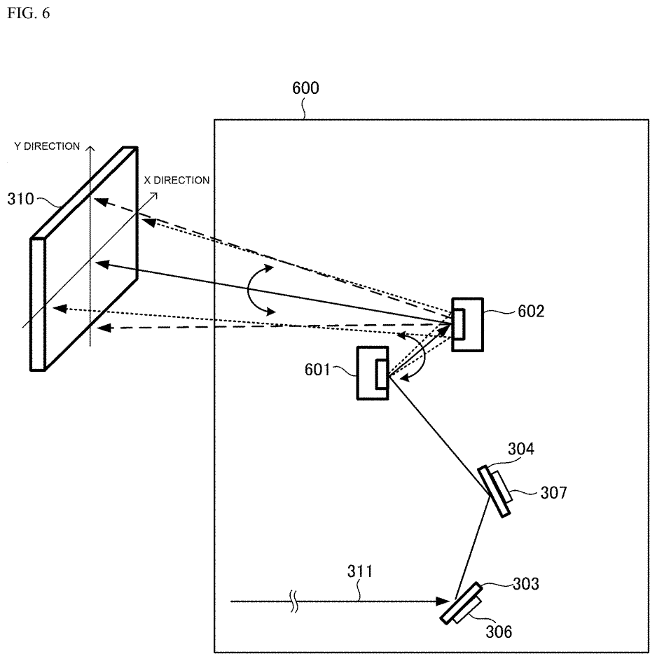

With reference to FIG. 6, an information processing unit according to the third embodiment of the present invention is then described. FIG. 6 is a diagram illustrating configuration of a projector 600 according to the present embodiment. The projector 600 according to the present embodiment differ from the second embodiment in having two one-dimensional scanning mirrors. Other configuration and operation are same as those in the second embodiment, and the same reference signs are given to the same configuration and operation to omit the detailed description. Note that, in FIG. 6, the light source is omitted from the illustration.

The projector 600 has a one-dimensional scanning mirror 601 and a one-dimensional scanning mirror 602. The one-dimensional scanning mirror 601 scans the light beam 311 reflected on the mirror 304 in the X direction. The light beam 311 scanned in the X direction by the one-dimensional scanning mirror 601 is then scanned in the Y direction by the one-dimensional scanning mirror 602. The light beam 311 scanned in the Y direction by the one-dimensional scanning mirror 602 is projected on the screen 310. The scanning directions by the one-dimensional scanning mirrors 601 and 602 may be vice versa.

Since the optical devices on an optical path are driven, the present embodiment allows reduction in speckle noise without increasing optical devices. In addition, since a mechanism to drive the optical devices on an optical path is provided, the present embodiment allows reduction in speckle noise with a simple configuration. Moreover, since the two one-dimensional scanning mirrors are used, the present embodiment improves the degree of freedom in disposing optical systems.

### Other Embodiments

While the present invention has been described with reference to the above embodiments, the present invention is not limited to these embodiments. Various modifications understood by those skilled in the art may be made to the present invention in the configuration and details withing the scope of the present invention. In addition, the scope of the present invention also includes all systems and devices that are made by any combination of separate characteristics included in the respective embodiments.

Still in addition, the present invention may be applied to a system configured from a plurality of devices or may be applied to a single device. Moreover, the present invention is also applicable to the case of supplying an information processing program to achieve the functions in embodiments directly or remotely to the system or the device. Accordingly, the scope of the present invention includes a program installed in a computer to achieve the functions of the present invention by the computer, a medium having the program stored therein, and a WWW (world wide web) server to download the program. In particular, the scope of the present invention includes at least a non-transitory computer readable medium having a program causing a computer to execute the processing steps included in the above embodiments.

This application claims priority based upon the prior Japanese Patent Application No. 2017-161700, filed in Japan Patent Office on Aug. 25, 2017, the entire disclosure of which is incorporated herein by reference.

1. A projector comprising:
a light source configured to generate light;
an optical system configured to reflect the light from the light source and guide the light to a two-dimensional scanning mirror;
the two-dimensional scanning mirror configured to project the light guided by the optical system on a screen; and
a driving mechanism configured to drive the optical system at a predetermined period and a predetermined amplitude.

2. The projector according to claim 1, wherein the driving mechanism drives the optical system in a predetermined direction.

3. The projector according to claim 2, wherein the driving mechanism further drives the optical system in a direction at a predetermined angle to the predetermined direction.

4. The projector according to claim 3, wherein the direction at a predetermined angle is a direction vertical to the predetermined direction.

5. The projector according to claim 1, wherein the optical system includes at least two mirrors.

6. The projector according to claim 5, wherein the driving mechanism provided in at least one of the at least two mirrors.

7. The projector according to claim 5, wherein the at least two mirrors include at least one of a dichroic mirror and a fold mirror.

8. The projector according to claim 1, wherein the light source includes a laser diode.

9. The projector according to claim 1, wherein the two-dimensional scanning mirror is configured to include two one-dimensional scanning mirrors.

10. A method of controlling a projector, the projector including
a light source configured to generate light,
an optical system configured to reflect the light from the light source and guide the light to a two-dimensional scanning mirror,
the two-dimensional scanning mirror configured to project the light guided by the optical system on a screen, and
a driving mechanism configured to drive the optical system at a predetermined period and a predetermined amplitude, the method comprising the steps of:
generating light from the light source;
projecting the generated light on the screen; and
driving the optical system.

11. A program for controlling a projector, the projector including
a light source configured to generate light,
an optical system configured to reflect the light from the light source and guide the light to a two-dimensional scanning mirror,
the two-dimensional scanning mirror configured to project the light guided by the optical system on a screen, and
a driving mechanism configured to drive the optical system at a predetermined period and a predetermined amplitude, the program causing a computer to execute a method of controlling the projector, the method including the steps of:
generating light from the light source;
projecting the generated light on the screen; and
driving the optical system.
